(19) United States
(12) Patent Application Publication
(10) Pub. No.: US 2014/0198618 A1
(43) Pub. Date: Jul. 17, 2014

(54) DETERMINING ROOM DIMENSIONS AND A RELATIVE LAYOUT USING AUDIO SIGNALS AND MOTION DETECTION

(71) Applicant: QUALCOMM INCORPORATED, San Diego, CA (US)

(72) Inventors: James B. CARY, San Diego, CA (US); Geoffrey C. WENGER, San Diego, CA (US); John D. BOYD, San Diego, CA (US); Michael J. MAGER, San Diego, CA (US); Pooja AGGARWAL, San Ramon, CA (US)

(73) Assignee: QUALCOMM INCORPORATED, San Diego, CA (US)

(21) Appl. No.: 13/740,242

(22) Filed: Jan. 13, 2013

(51) Int. Cl. G01S 15/08

(52) U.S. Cl. CPC G01S 15/08
USPC 367/99

(57) ABSTRACT

Methods and apparatus are provided for determining room dimensions and layout. A method includes receiving an audio signal from at least one other detection apparatus. The method includes determining a spatial orientation of a detection apparatus along a substantially planar surface. The method includes calculating at least one dimension along the planar surface based in part on the received audio signal and the determined spatial orientation of the detection apparatus. Methods and apparatus are provided for determining room layout. The method includes detecting a mobile object in a first room. The method includes receiving an indication of detection of the mobile object in a second room subsequent to the detection in the first room. The method includes providing an indication that the first and second rooms are adjacent rooms based on the detection of the mobile object in the second room subsequent to the detection in the first room.

### FIELD

Aspects of the present disclosure relate generally to methods and apparatus for determining dimensions and more particularly to audio and motion detection-based determination for room dimensions and relative layout.

### BACKGROUND

Measuring room (e.g., of a dwelling, office building, factory) dimensions and relative layouts of the rooms is a common task usually requiring manual estimation to ascertain the dimensions of the room. Common ways to make measurements of rooms include using a tape measure or laser range finder. Using a tape measure or other manual instrument, however, is often laborious and inaccurate. The user may be required to make estimates based on the manual processes. The accuracy of the laser range finder depends on the amount of diligence and care taken by the user. In cases where the rooms are relatively large, such as a large factory, the standard methods for measuring room dimensions may be time consuming and inaccurate. Therefore, there is a need for better methods to measure room dimensions and relative layouts of the rooms.

### SUMMARY

Methods, apparatus, and systems for determining room dimensions and room layouts are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method for dimensions of an enclosure may include receiving, at a detection apparatus, an audio signal from at least one other detection apparatus. The method may include determining a spatial orientation of the detection apparatus along a substantially planar surface of the enclosure. The method may include calculating at least one dimension along the planar surface based in part on the received audio signal and the determined spatial orientation of the detection apparatus.

In another aspect, a method for determining room layout may include detecting a mobile object in a first room. The method may include receiving an indication of detection of the mobile object in a second room subsequent to the detection in the first room. The method may include providing an indication that the first and second rooms are adjacent rooms based on the detection of the mobile object in the second room subsequent to the detection in the first room.

In related aspects, a sensor module or detection apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as a computer server, system controller, control point or mobile computing device. Similarly, an article of manufacture may be provided, including a computer-readable storage medium holding encoded instructions, which when executed by a processor, cause a computer to perform the methods and aspects of the methods as summarized above.

### BRIEF DESCRIPTION OF THE DRAWINGS

FIG. 1 is a block diagram conceptually illustrating an example sensor module deployment for determining room dimensions.

FIG. 2 illustrates an exemplary sensor module as used in the example of FIG. 1.

FIG. 3 illustrates an exemplary measurement process between a pair of sensor modules, such as sensor modules 102a, 102b of FIG. 1.

FIG. 4 a block diagram conceptually illustrating an example sensor module deployment for determining room dimensions and relative room layout.

FIG. 5 is a sequence diagram illustrating a use case of the sensor modules in a centralized processing configuration.

FIGS. 6A-C are sequence diagrams illustrating another use case of the sensor modules, e.g., in a distributed processing configuration.

FIGS. 7-10 illustrate embodiments of a methodology for determining room dimensions and layout.

FIG. 11 illustrates an example of an apparatus for implementing the methodologies of FIGS. 7-10.

FIGS. 12-13 illustrate embodiments of a methodology for determining room layout.

FIG. 14 illustrates an example of an apparatus for implementing the methodologies of FIGS. 12-13.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present disclosure concerns methods and apparatus for leveraging audio detection and motion detection to make the process of measuring room dimensions and layout easier and more accurate, e.g., for a home owner or office/factory worker. Rather than using the physical tape measures that may be laborious and inaccurate or hand held range finders that require line of sight, the home owner or office/factory worker may choose to use the more accurate and easier processes embodied in the sensor module deployments below.

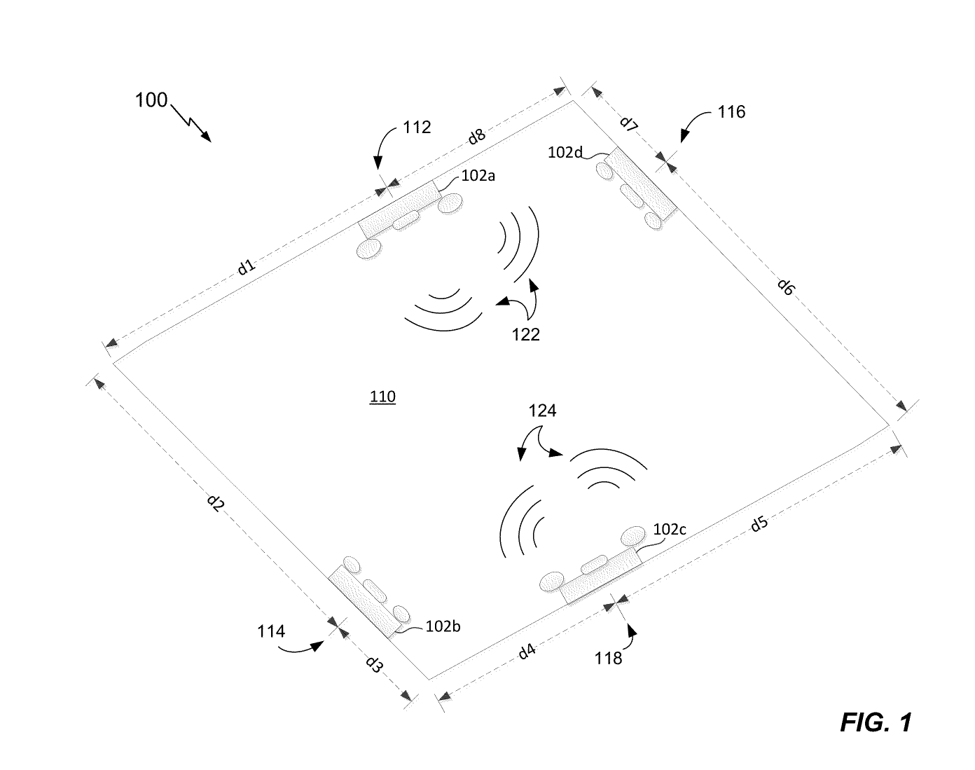

Referring to FIG. 1, a sensor module, or detection apparatus, deployment for determining room dimensions is shown. Sensor module and detection apparatus may be used interchangeably in this disclosure. The sensor module deployment 100 may include a network of sensor modules 102a, 102b, 102c, 102d, installed in a space 110 or enclosure, for example, of a home, office, or factory. Each sensor module 102 may include microphones, speakers, clocks, magnetometers, and a wireless radio assembly, including a transceiver, receiver, and/or antenna. Each sensor module 102 may also include at least one processor and a memory for implementing the methods of the sensor module 102.

The sensor modules 102a, 102b, 102c, 102d may be configured in a distributed fashion (e.g., peer-to-peer) with processing distributed among the set of sensor modules 102a, 102b, 102c, 102d. In the distributed setup, the sensor modules 102a, 102b, 102c, 102d communicate with each other and process the information at a processor of each sensor module. Alternatively or additionally, the sensor modules may be configured for centralized deployment. In a centralized setup, the system may further include a server to collect data from the sensor modules and coordinate activities of the sensor modules. In the centralized setup, the sensor modules may perform rudimentary calculations and/or forward all collected data to the server for processing.

The sensor modules 102a, 102b, 102c, 102d may be placed in the space 110 at locations suitable for determining dimensions of the space 110. The sensor modules 102a, 102b, 102c, 102d may be placed parallel (e.g., flat or flush against a surface) to the walls or sides of the space 110. The sensor modules may be equipped with a magnetometer (e.g., a compass) for reading an orientation of the adjoining wall. Further, the sensor modules 102a, 102b, 102c, 102d may be placed at the same or substantially similar height. For example, a user installing the sensor modules 102a, 102b, 102c, 102d into the space 110 may place all the sensor modules 102a, 102b, 102c, 102d at eye level to ensure the modules are at the same height.

For example, in the space 110 containing four sides or walls shown in the example of FIG. 1, the sensor modules 102a, 102b, 102c, 102d may be placed on each of the four sides of the space 110. Generally, one sensor module may be placed on each side of a given space. The specific location of the sensor modules 102a, 102b, 102c, 102d along the length of wall may not be important, because the sensor module may be able to account for displacement from the center of the wall. In the example of FIG. 1, sensor module 102a is located at location 112, dividing the length of the adjoined side into two lengths, d1 and d8. When the sensor module is placed in the middle, the two lengths may be equal. Alternatively when the sensor module is placed at an offset from the center of the wall, one side (e.g., d1) may be longer than the other side (e.g., d8). Sensor module 102b is located at location 114, dividing the length of the adjoined side into two lengths, d2 and d3. Sensor module 102c is located at location 118, dividing the length of the adjoined side into two lengths, d4 and d5. Sensor module 102d is located at location 116, dividing the length of the adjoined side into two lengths, d6 and d7. The sensor modules may be deployed in spaces having three or more sides or walls, with one sensor module placed on each side or wall.

Once deployed in the space 110, the sensor modules 102a, 102b, 102c, 102d may calculate the room dimensions automatically, without further user input or interaction. The absence of user input or user interaction may improve the accuracy of the measurements as human error may be removed from the measurements. Further, the time to perform the measurements may be vastly improved over manual measurements as the audio detection-based measurements may be limited only by the speed of propagation of electromagnetic and sound signals.

To initiate the process for determining the room dimensions, the sensor modules 102a, 102b, 102c, 102d may be configured to initiate the process, for example, based on a trigger to begin at a predetermined time. Alternatively, the sensor modules may be triggered to initiate the process based on, for example, an input, such as a message over the network, voice activation, a button on the sensor module to initiate the process, or detection of an object in the space 110. In a centralized setup, the server may coordinate the initiation process. For example, the central server may send an initiation message to one or more of the sensor modules 102a, 102b, 102c, 102d to begin the process.

The room dimension determination is based on calculated distances between pairs of sensor modules and orientations of the sensor modules. To determine distances between the sensor modules, the time of travel for audio signals is used. Once the process is started, the sensor modules 102a, 102b, 102c, 102d emit audio signals for the other sensor modules 102a, 102b, 102c, 102d. Based on the time for the audio signal to reach the receiving sensor module, a distance between the transmitting and receiving sensor modules may be determined. For example, if an audio signal takes two seconds to travel from sensor module 102a to sensor module 102b, then the distance is approximately 686.4 meters because the audio signal (e.g., sound wave) travels 343.2 meters in a second (if measured in a dry space at 20 degrees Celsius). The sensor modules may be calibrated based on the location and environment conditions, factoring in the altitude, humidity, temperature, and other conditions. Those skilled in the art will recognize that the other signals, such as electromagnetic signals, may be used to determine distances between objects.

In one embodiment, e.g., in a distributed scenario, the sensor modules initiate the process based on an input or trigger. The process may begin by synchronizing the clocks of the sensor modules 102a, 102b, 102c, 102d. In an example, sensor module 102a transmits a signal (e.g., wireless/wired signal) to synchronize the clocks of the other sensor modules 102b, 102c, 102d. After a predetermined time period (e.g., 1 millisecond), or after a random time period, sensor module 102a emits an audio signal 122 to allow the other sensor modules to determine a distance to sensor module 102a. Sensor modules 102b, 102c, 102d each receives the audio signal from sensor module 102a at multiple (e.g., 2) microphones and calculates a distance to sensor module 102a based on the travel time of the audio signal. The starting time of the audio signal 122 transmission may be contained in the audio signal itself or transmitted separately (e.g., in a network message). For example, the audio signal may be a time signal indicating the starting time of transmission. Detecting the audio signal at multiple microphones (e.g., at multiple locations) allows the receiving sensor module to determine a distance, location, and/or position of the transmitting sensor module. Each sensor module reads its orientation, e.g., using a magnetometer or compass. Each sensor module may know or receive an orientation of the other sensor modules. Based on the distance to sensor module 102a and the orientations, sensor module 102b may calculate the lengths of the adjacent sides d1, d2 between sensor module 102a and sensor module 102b. Based on the distance to sensor module 102a and the orientations, sensor module 102d may calculate the lengths of the adjacent sides d8, d7 between sensor module 102a and sensor module 102d. Sensor module 102c might assume it is located on a wall adjacent to the wall of sensor module 102a, when sensor module 102c is in fact not adjacent to the wall of sensor module 102a. Sensor module 102c may determine it is not adjacent to sensor module 102a, e.g., based on information from sensor module 102b and/or 102d, and avoid calculating invalid lengths, or sensor module 102c may make the calculations with the calculations discarded at a later time. Sensor module 102b, 102d may optionally broadcast the calculated lengths.

After sensor module 102a has transmitted its audio signal, one of sensor modules 102b, 102c, 102d may transmit an audio signal to determine the other remaining lengths of the space. Each sensor module may wait for a random period of time or may be configured to transmit in a predetermined order (e.g., 102a first, 102c second, 102b third, and 102d fourth). Sensor module 102c may transmit an audio signal 124 next. Sensor modules 102a, 102b, 102d receive the audio signal. Each sensor module reads its orientation, e.g., using a magnetometer or compass. Each sensor module may know or receive an orientation of the other sensor modules. Based on the distance to sensor module 102c and the orientations, sensor module 102b may calculate the lengths of the adjacent sides d3, d4 between sensor module 102b and sensor module 102c. Based on the distance to sensor module 102c and the orientations, sensor module 102d may calculate the lengths of the adjacent sides d5, d6 between sensor module 102c and sensor module 102d. Sensor module 102a might assume it is located on a wall adjacent to the wall of sensor module 102c, when sensor module 102a is in fact separated by another wall. Sensor module 102a may determine it is not adjacent to sensor module 102a, e.g., based on information from sensor module 102b and/or 102d, and avoid calculating invalid lengths, or sensor module 102a may make the calculations with the calculations discarded at a later time. Sensor modules 102b, 102d may optionally broadcast the calculated lengths. All lengths d1-d8 are calculated after two transmitted audio signals.

As evident from the discussion above, not all sensor modules may be required to transmit an audio signal for the sensor modules to determine all the dimensions of the space. For example, audio signals from sensor modules 102a, 102c are sufficient to enable the determination of distances between all adjacent pairs (102a/102b, 102b/102c, 102c/102d, and 102a/102d). In another example, audio signals from sensor modules 102b, 102d enable the determination of distances between all adjacent pairs. Alternatively, audio signals from any three sensor modules in the example of FIG. 1 are sufficient to enable the determination of distances between all adjacent pairs. In general, if there are n walls with n sensor modules, then m=ceiling(n/2) of audio signal transmissions are required to determine all dimensions of the space. In some instances, e.g., for greater accuracy or validation of measurements, all sensor modules may emit audio signals. Each sensor module in a respective pair may calculate the distance independently to validate the measurement of the other sensor module in the pair, or two independent measurements may be averaged for greater accuracy.

Once all the lengths are calculated, the sensor modules may optionally broadcast the lengths so that all sensor modules have all lengths of the space 110. Additionally or alternatively, the sensor modules 102a, 102b, 102c, 102d may send the calculated dimensions to a server or central location for storage and/or further processing. Additionally or alternatively, the sensor modules 102a, 102b, 102c, 102d may send the measurements to a user device, e.g., smartphone, or an online server for storage and/or display.

In a centralized scenario, the central server may coordinate the calculations. The central server may initiate the room dimension determination process. The server may optionally send a message to synchronize the clocks of the sensor modules 102a, 102b, 102c, 102d. The server may then request one sensor module to transmit the audio signal. For example, sensor module 102a may be requested to transmit the audio signal 122. Sensor modules 102b, 102c, 102d receive the audio signal 122 from sensor module 102a at multiple microphones. In one aspect, the other sensor modules 102b, 102c, 102d may calculate a distance to sensor module 102a and/or adjacent lengths of the space 110. In another aspect, the sensor modules 102b, 102c, 102d transmit any combination of the time of receipt of the audio signal 122, distance to sensor module 102a, or the adjacent lengths to the server. The server may repeat the steps for sensor module 102b, to request sensor module 102b to transmit the audio signal. Based on the received information, the central server may calculate any of the distances and room dimensions as necessary.

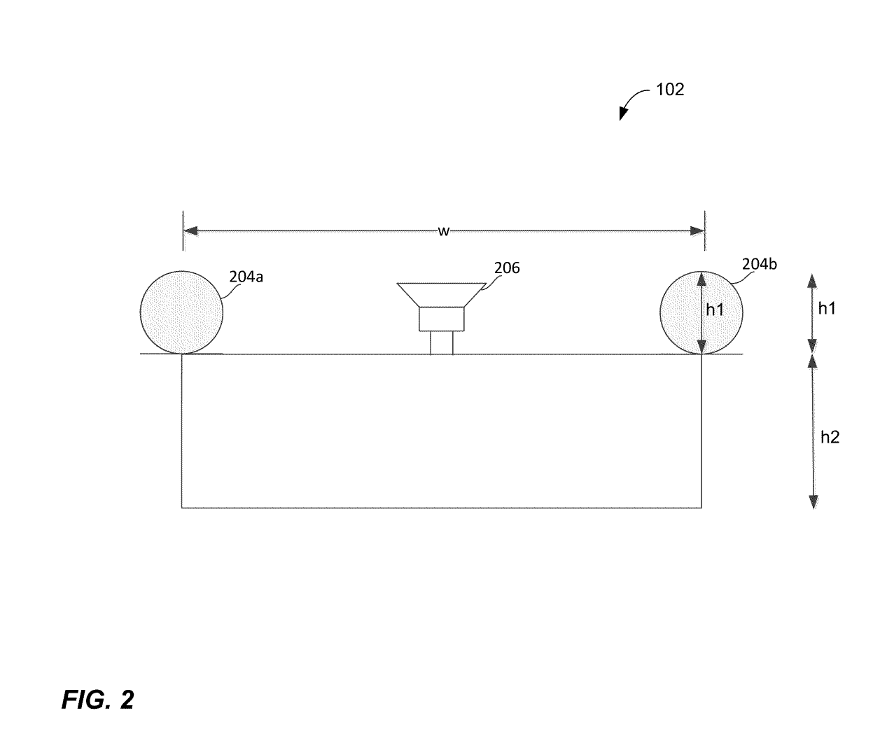

FIG. 2 illustrates an exemplary sensor module 102 of FIG. 1. The sensor module 102 has a depth of ‘h2’ and may include a speaker 206 and microphones 204a, 204b. The microphones may be offset by a distance ‘w’. The two microphones may detect audio signals at two independent times and allow the sensor module 102 to determine the distance, location, and position of a transmitter in two-dimensional space. While the speaker 206 is shown on the outside body of the sensor module 102, one skilled in the art will recognize that the speaker 206 may be placed anywhere within or on the body of the sensor module 102. While the speakers are shown with diameter ‘h1’, one skilled in the art will recognize that the microphones 204a, 204b may have any suitable size or diameter ‘h1’. One skilled in the art will recognize that the sensor module 102 may have any appropriate depth ‘h2’.

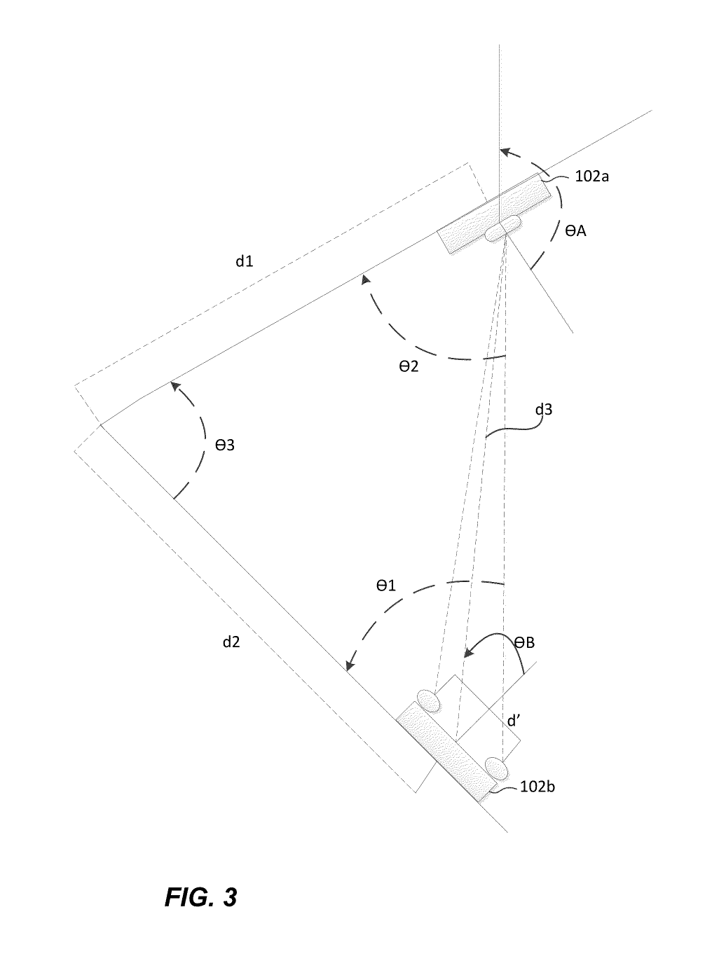

FIG. 3 illustrates an exemplary measurement process between a pair of sensor modules, such as sensor modules 102a, 102b of FIG. 1. Sensor module 102a is placed at a location on a side of the space such that the length of the adjacent side is d1. Sensor module 102b is placed at a location on another side of the space such that the length of the adjacent side is d2. Sensor modules 102a, 102b may follow a process to find the lengths d1, d2 of the sides as follows. In one embodiment, sensor module 102a and sensor module 102b synchronize their clocks over a wireless link. Then, sensor module 102a emits an audio signal from its speaker. After time t1, sensor module 102b microphone one (e.g., 204a) picks up the audio signal, and after time t2, sensor module 102b microphone two (e.g., 204b) picks up the audio signal. The distance between sensor module 102a and sensor module 102b is computed based on the speed of sound (e.g., 343.2 m/s in a dry space at 20 degrees Celsius) and time t1 to give distance d3. The angle of arrival of the sensor module 102 audio signal at sensor module 102b is computed based on the time delay of arrival, t2−t1, of the audio signal between sensor module 102b's microphones (e.g., 204a, 204b) and the distance d′ between sensor module 102b's microphones (e.g., 204a, 204b) to give ⊖1.

The wall displacements between sensor modules 102a and sensor module 102b may be computed, e.g., using the law of sines. The angle of the walls may be computed using the magnetometer or compass readings of both sensor module 102a, ⊖A, and sensor module 102b, ⊖B. The magnetometer or compass readings may be communicated between the sensor modules, e.g., over the network, via the audio signal, or in other ways. The lengths of the adjacent sides may be computed as follows:

⊖3=180−|(90−⊖A)|−|(90−⊖B)|

⊖1=90−⊖B; ⊖2=⊖A−90.

For example, applying the law of sines:

d1/sin(⊖1)=d2/sin(⊖2)=d3/sin(⊖3).

Solving for d1:

d1/sin(⊖1)=d3/sin(⊖3);

d1=d3*sin(⊖1)/sin(⊖3).

Solving for d2:

d2/sin(⊖2)=d3/sin(⊖3);

d2=d3*sin(⊖2)/sin(⊖3).

In such fashion, the adjacent sides of the two sensor modules are calculated. The calculations may be performed at the sensor modules, e.g., in a distributed scenario, or at a server, e.g., in the case of a centralized scenario. The same procedure is repeated for the other adjacent sides so that all the lengths are determined. One skilled in the art will recognize that the lengths may be determined based on other functions and methods. For example, the law of cosines, tangents, other mathematical functions, geometric approximations, etc., may be used to calculate the lengths.

In one embodiment, the sensor modules may be sufficiently small such that the dimensions of the sensor modules may not affect the calculations. In smaller rooms, or where the sensor module is relatively large in comparison to the dimensions of the space, the size and dimensions of the sensor modules may affect the calculations. In such instances, the known dimensions of the sensor module may be factored in to the calculations above. For example, the depth of the sensor module may be factored into the calculations above. The additional size and dimensions of the speaker component may also be factored into the calculations.

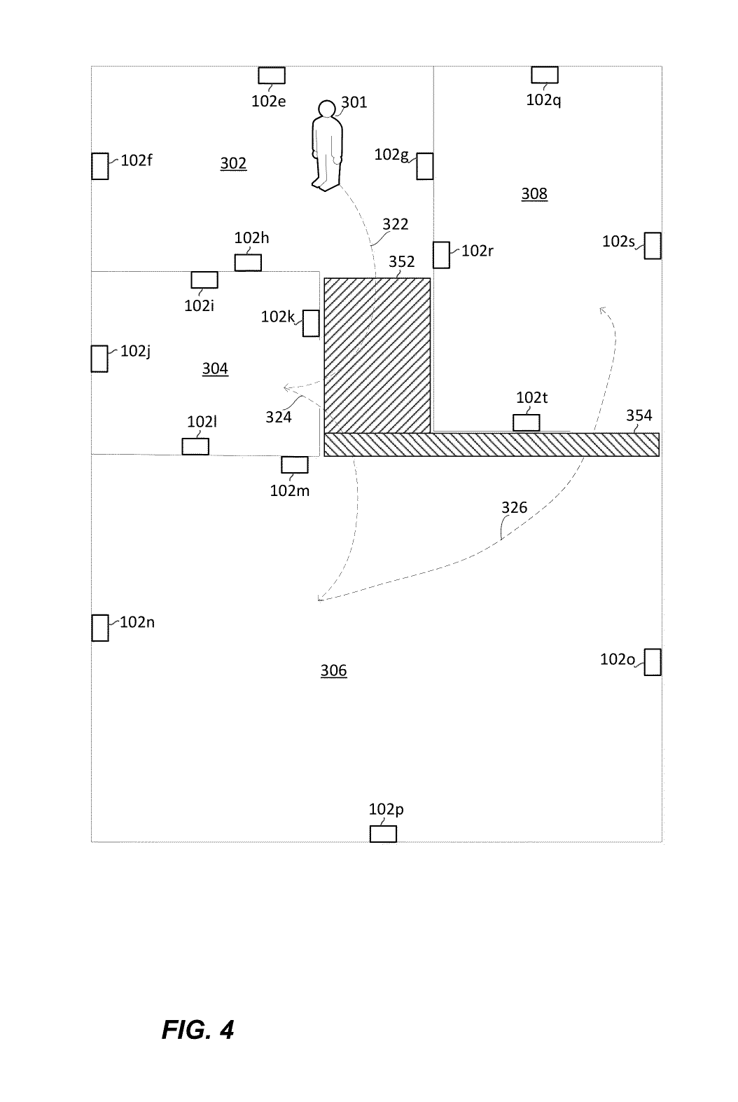

FIG. 4 a block diagram conceptually illustrating an example sensor module deployment for determining room dimensions and relative room layout. Each room is four sided. The disclosure, however, is not limited to rooms having four sides, and may have any number of sides of three or more. The determination of relative room layout (e.g., which rooms are adjacent to which other rooms) may employ a mobile object 301 (e.g., a person or vehicle) that moves from one room to another. As the mobile object 301 moves from room to room, the sensor modules 102 detect the mobile object 301 to determine the layout. Each sensor module 102 may be outfitted with a wireless radio assembly which may perform tomographic imaging. Through radio tomography, the sensor modules 102e-t may determine if the mobile object 301 is moving in the room. Therefore, to determine if one room is adjacent to another room, the sensor modules of all rooms continuously poll to determine which room the mobile object 301 is currently in and mark that room. The sensor modules 102e-t continue to poll until the mobile object 301 is detected in another room. The two rooms are marked adjacent to each other based on the movement of the mobile object 301. The process continues until all rooms have been accounted for.

In the example illustrated in FIG. 4, the mobile object 301 starts at room 302. The sensor modules 102e-h of room 302 detect the presence of the mobile object 301 and may signal the mobile object's 301 presence in the room 302 to the other sensor modules or to a server. The mobile object 301 may then visit room 304 via path 322. Sensor modules 102i-1 in room 304 detect the mobile object's 310 presence. Based on the detected mobile object's presence, room 304 is marked as being adjacent to room 302. The mobile object 301 may continue visiting rooms 306, 308 via the respective paths 324, 326 for the sensor modules to determine adjacent rooms 306, 308. The process may be completed with all adjacent room relationships marked once the mobile object 301 visits room 308 via path 326.

Certain areas, such as hallways or corridors of a building may not be included in the room dimension determination process. In the example of FIG. 4, the areas 352, 354 are small sections between the rooms. The areas 352, 354 may be optionally determined based on the results of the determined dimensions of the rooms. For example, the dimensions of area 352 may be based on the dimensions of room 302 and 304. Area 352 shares a dimension (adjacent to sensor module 102j) with room 304, with another dimension of area 352 being the difference between the adjacent side of sensor module 102e and adjacent side of sensor module 102i.

Signals and/or other transmissions from adjacent rooms may cause confusion in a sensor module located in another room. For example, sensor module 102i in room 304 may overhear signals from sensor module 102g in room 302, and sensor module 102i may attempt to calculate room dimensions based on the signals from sensor module 102g. The calculated room dimensions using the signals between sensor modules 102g and 102i may be invalid because the sensor modules 102g and 102i are in different rooms. In one aspect, the potential confusion may be resolved using the adjacent room determination information. For example, each sensor module may know, based on the adjacent room determination, that the sensor module belongs to a specific room and only make calculations based on signals received from other sensor modules in the same room. As another example, the measurement process may be initiated by the server because the server may know the location of each sensor module, e.g., based on the adjacent room determination. In another aspect, the sensor modules may calculate the room dimensions based on any received signals and keep the shortest measurement while discarding the longer measurements for signals received from sensor modules at a same or substantially similar orientation. For example, sensor module 102i may make measurements based on signals from sensor module 102k in the same room 304 and also based on signals from sensor module 102g in room 302. Sensor modules 102k and 102g have a same orientation so only one of the sensor modules may be in the same room as sensor module 102i. The measurements based on the signals from sensor module 102k will be shorter than measurements from sensor module 102g. Sensor module 102i may keep the shorter measurements based on signals from sensor module 102k and discard the longer measurements based on signals from sensor module 102g. In yet another aspect, described below, the presence of the mobile object 301 may help to resolve the confusion.

The detection of the presence of the mobile object 301 may trigger the sensor modules in a room to initiate the room dimension calculation process in the room. For example, when the mobile object 301 arrives in room 302, the sensor modules 102e-h may initiate the room dimension calculation process. Sensor modules in other rooms that did not detect the mobile object 301 may ignore the signals from the sensor modules 102e-h. As the mobile object 301 moves to other adjacent rooms, the process is initiated in the other rooms. The process continues until the mobile object 301 reaches the last room (e.g., room 308).

Once all the room dimensions are calculated and the room layout is mapped, the information may be stored and/or presented to the user.

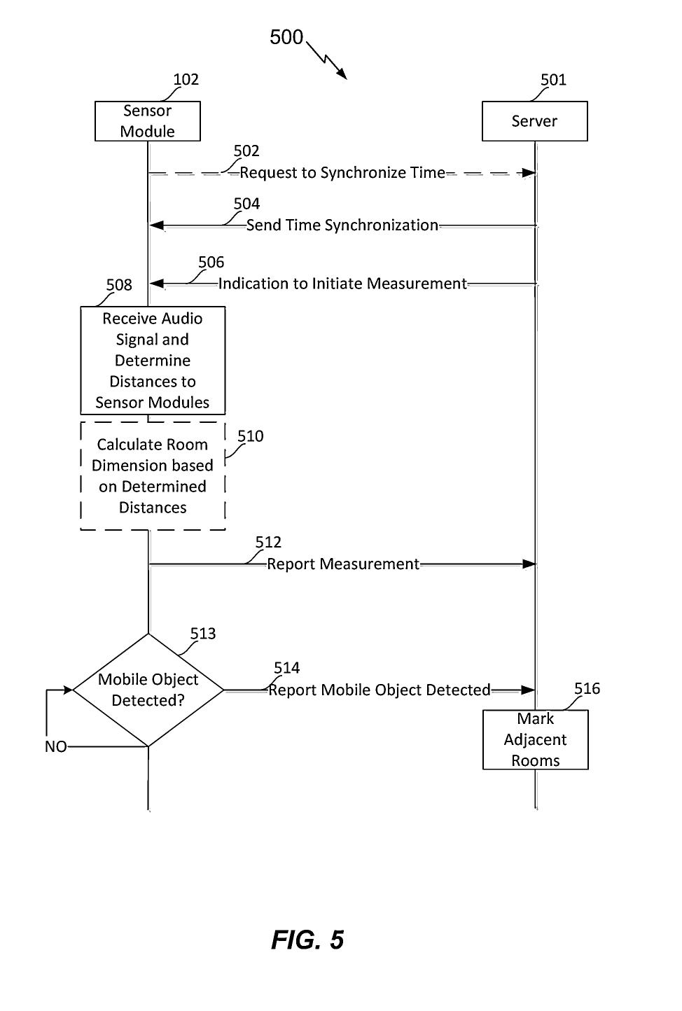

Another perspective of the foregoing embodiments is provided by the use case 500 illustrated in FIG. 5. It should be appreciated that the illustrated use case does not exclude other use cases for the foregoing system and apparatus. The illustrated use case 500 includes interactions between a sensor module 102 and a server 501, e.g., in a centralized system.

At 502, the sensor module 102 optionally sends a request to synchronize the time. At 504, the server 501 may send a time synchronization message to the sensor module 102. The time synchronization message may be in response to the request for time synchronization from step 502. At 506, the server may send an indication to initiate measurement of a space. At 508, the sensor module 102 may receive audio signals and determine distances to other sensor modules in the space. At 510, the sensor module 102 optionally calculates room dimensions based on the determined distances. At 512, the sensor module 102 sends the information including the determined distances and optionally the calculated room dimensions to the server 501. At 513, the sensor module 102 proceeds to detect the presence of a mobile object. If the mobile object is not detected, the sensor module 102 returns to 513 to detect the presence of the mobile object. If the mobile object is detected, the sensor module 102 reports the detection of the mobile object to the server 501. At 516, based on the detected mobile object, the server 501 may mark rooms as adjacent.

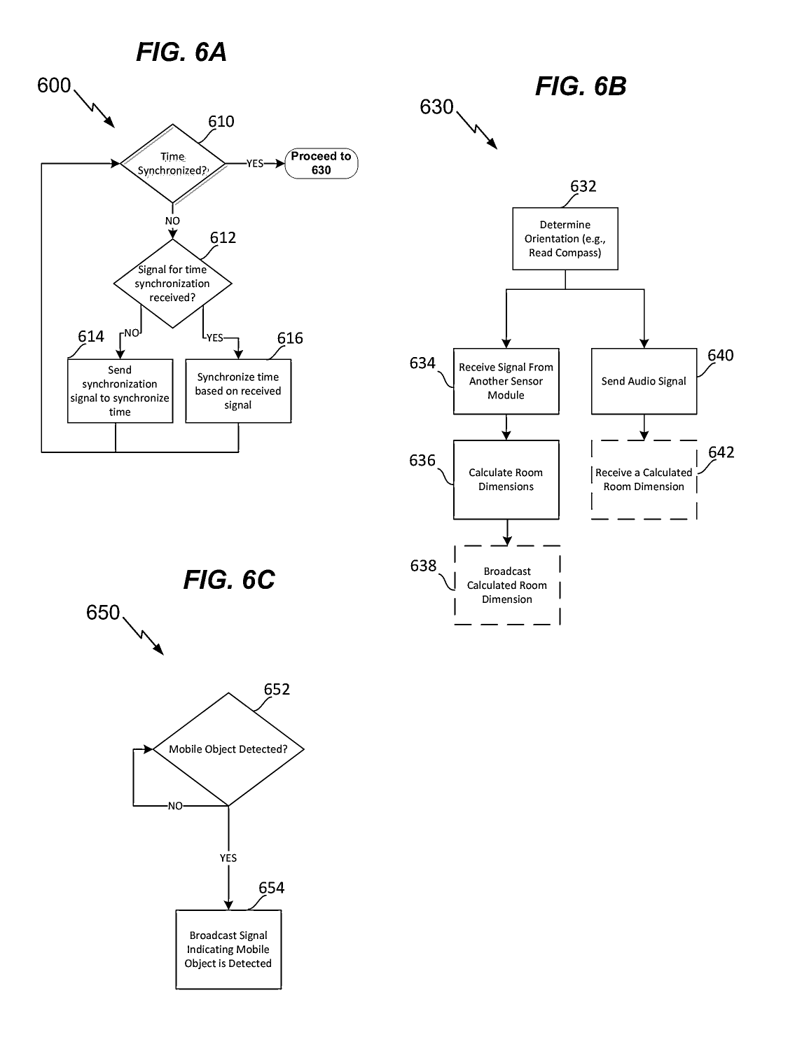

Yet another perspective of the foregoing embodiments is provided by the use cases 600, 630, and 650 illustrated in FIGS. 6A-C. It should be appreciated that the illustrated use cases do not exclude other use cases for the foregoing system and apparatus. The illustrated use cases 600, 630, and 650 include interactions between sensor modules. At 610, the sensor module determines if a time is synchronized. If the time is not synchronized, then, at 612, the sensor module may determine whether a time synchronization signal was received. If time synchronization signal was not received, then, at 614, the sensor module may send a time synchronization signal (e.g., wireless/wired signal). If the synchronization signal (e.g., a time marker) was received, then, at 616, the sensor module may synchronize the time. The synchronization signal may be a time marker or other time synchronization indicator. The process loops back to step 610. Once the time is synchronized, then the sensor module may proceed to calculate room dimensions at 630.

In FIG. 6B the sensor module may start the room measurement process. At step 632, the sensor module determines its orientation or direction, such as a heading in degrees or radians. The sensor module, at 634, may receive a signal, such as an audio signal, from another sensor module. The sensor module may receive a time indication along with or separate from the audio signal. For example, the sensor module may receive a wired/wireless signal indicating a time. Based on the received signals, at 636, the sensor module may calculate the room dimensions. Optionally, at 638, the sensor module may broadcast the calculated room dimensions. Alternatively or in addition, at 640, the sensor module may send an audio signal for calculating room dimensions. Another sensor module may receive the audio signal and calculate room dimensions. At 642, the other sensor module may optionally receive the calculated room dimensions from the other sensor module.

After the dimensions are calculated, the sensor modules may communicate information to determine adjacent room layouts in 650 of FIG. 6C. For example, at step 652, the sensor module may determine whether a mobile object was detected. If the mobile object was not detected the sensor module waits to repeat the procedure to detect the mobile object. If the mobile object was detected, the sensor module, at 654, sends a signal indicating that the mobile object is detected. Based on received signals from other sensor modules indicating the presence of the mobile object, the sensor module may determine adjacent rooms.

Methodologies that may be implemented in accordance with the disclosed subject matter may be better appreciated with reference to various flow charts. For purposes of simplicity of explanation, methodologies are shown and described as a series of acts/operations. However, the claimed subject matter is not limited by the number or order of operations, as some operations may occur in different orders and/or at substantially the same time with other operations from what is depicted and described herein. Moreover, not all illustrated operations may be required to implement methodologies described herein. It is to be appreciated that functionality associated with operations may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

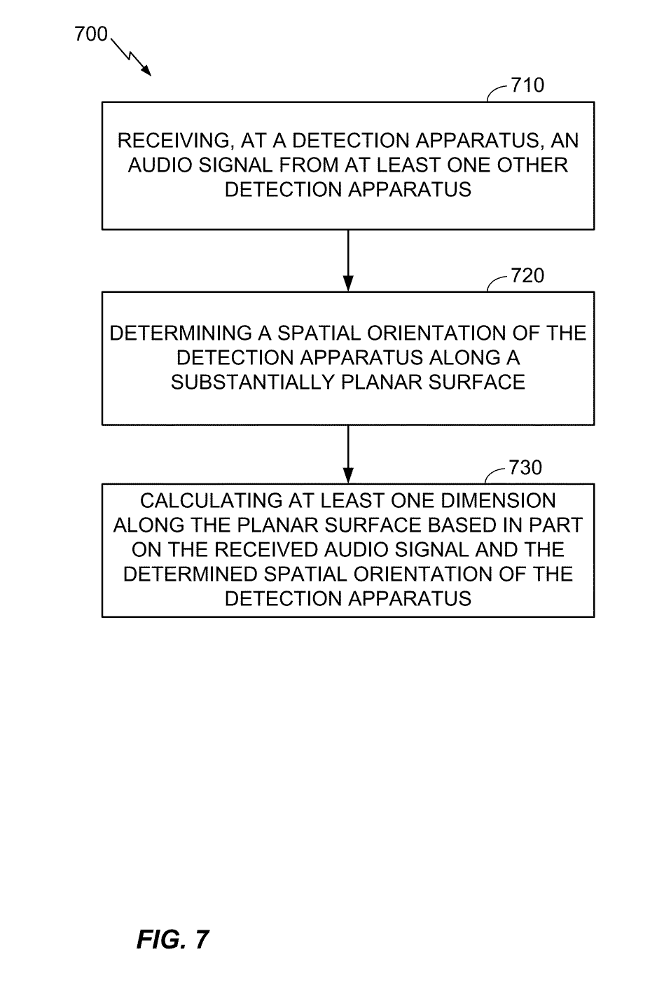

FIGS. 7-10 illustrate related methodologies for determining room dimensions and layout by sensor modules, for example, in a distribute system or a centralized system.

The method 700 may include, at 710, receiving an audio signal from at least one other detection apparatus. For example, the audio signal may be received at the sensor module or a detection apparatus. For example, the sensor module may receive an audio signal from another sensor module. The method may include, at 720, determining a spatial orientation of the detection apparatus along a substantially planar surface. For example, the sensor module may be placed flush against a planar surface such as a wall. The sensor module may include a magnetometer. The sensor module may read the magnetometer to determine an orientation of the wall.

The method 700 may include, at 730, calculating at least one dimension along the planar surface based in part on the received audio signal and the determined spatial orientation of the detection apparatus. For example, the sensor module may determine adjacent lengths of a wall based on the audio signal and the spatial orientation. The sensor module may calculate a distance to another sensor module that transmitted the audio signal. Based on the distance and orientations, the sensor module may calculate adjacent lengths of a wall between the sensor module and an adjacent sensor module.

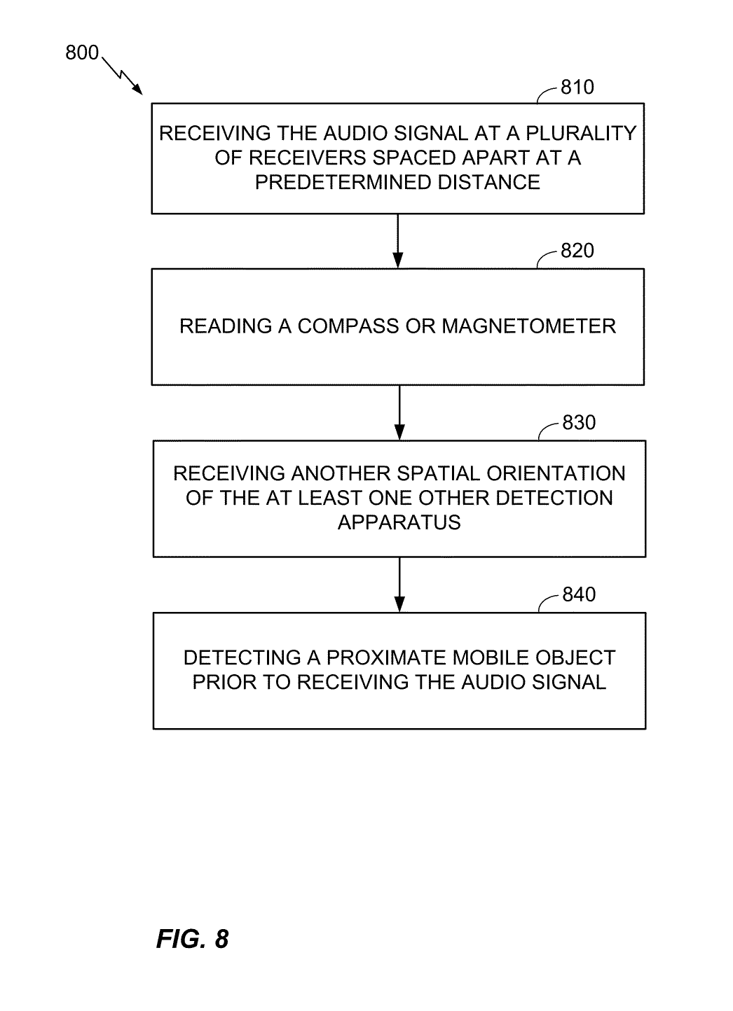

Additional operations 800, 900, and 1000 for determining room dimensions and layout are illustrated in FIG. 8-10. One or more of operations 800, 900, and 1000 may optionally be performed as part of method 700. The operations 800, 900, and 1000 may be performed in any operative order, or may be encompassed by a development algorithm without requiring a particular chronological order of performance. Operations may be independently performed and not mutually exclusive. Therefore any one of such operations may be performed regardless of whether another downstream or upstream operation is performed. For example, if the method 700 includes at least one of the operations 800, 900, and 1000, then the method 700 may terminate after the at least one operation, without necessarily having to include any subsequent downstream operation(s) that may be illustrated.

Referring to FIG. 8, the additional operations 800 may include, at 810, receiving the audio signal at a plurality of receivers spaced apart at a predetermined distance. For example, the calculating at least one dimension may be further based on a time difference in receiving the audio signal at the multiple receivers. The time difference in receiving the audio signal allows the sensor module to determine the location or position of the transmitting sensor module. Alone with orientation information of the other transmitting sensor modules, the information may be used to determine the adjacent lengths of between the two sensor modules. For example, the law of sines may be used with the distance between the sensor modules and orientations of the two sensor modules to determine the lengths of the adjacent sides.

The additional operations 800 may include, at 820, reading a compass or magnetometer. For example, the sensor module may include the compass or magnetometer coupled to a processor of the sensor module. Based on the reading of the compass or magnetometer, the sensor module may determine the dimensions of the room. The additional operations 800 may include, at 830, receiving another spatial orientation of the at least one other detection apparatus. For example, calculating the at least one dimension may be further based on the another spatial orientation of the at least one other detection apparatus. The additional operations 800 may include, at 840, detecting a proximate mobile object prior to receiving the audio signal. The proximate mobile object may be moving object such as user of the system. Proximity detection techniques such as radio tomography may be used to detect the mobile object.

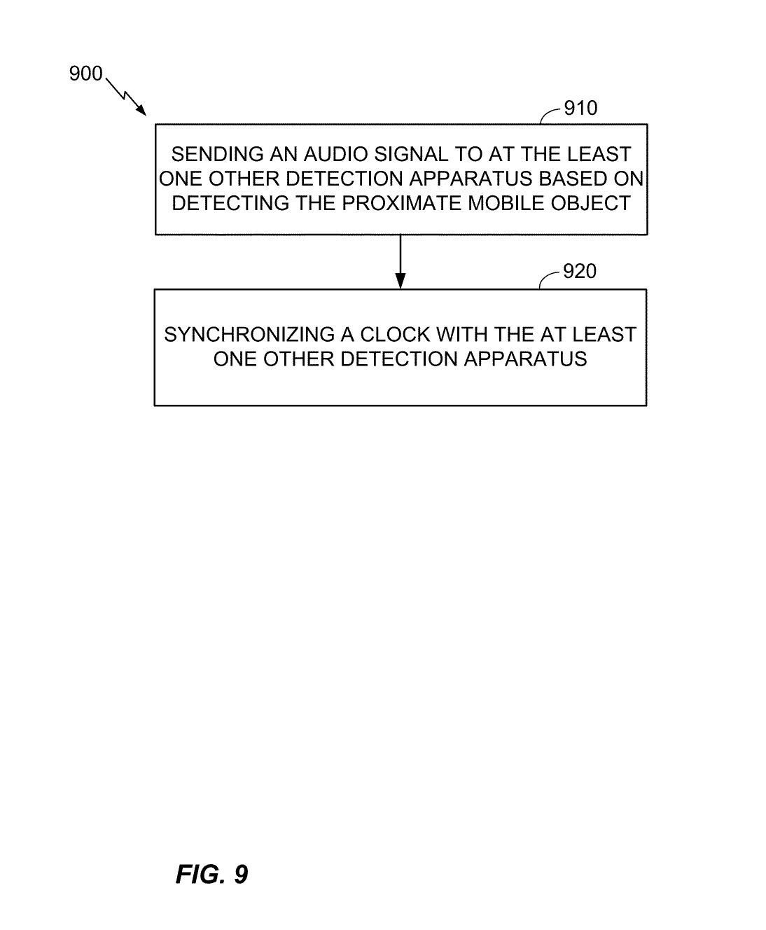

Referring to FIG. 9, the additional operations 900 may include, at 910, sending an audio signal to the at least one other detection apparatus based on detecting the proximate mobile object. For example, the detection of the mobile object may be used to determine room layout. For example, the sensor modules may communicate the detection of mobile object to determine the room layout. The mobile object may enter a first room. The sensor modules in the first room detect the presence of the mobile object and broadcast the information. As the mobile object enters a second room, the sensor modules in the second room detect and broadcast the presence of the mobile object. Based on the broadcast information from the first room and second room, the sensor modules may determine that first and second rooms are adjacent. The process may repeat until all layouts for all rooms are known. The additional operations 900 may include, at 920, synchronizing a clock with the at least one other detection apparatus.

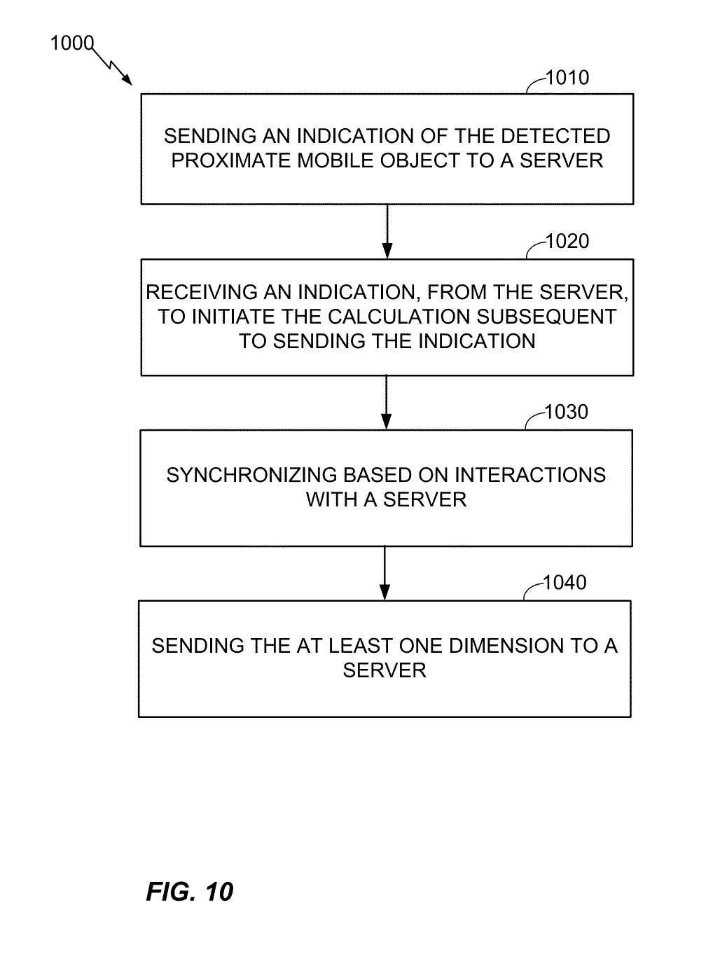

As shown in FIG. 10, additional operations 1000 may include, according to a first alternative at 1010, sending an indication of the detected proximate mobile object to a server. For example, the system may be configured for centralized operation. The sensor module may transmit information including detection of the mobile object to a centralized server. The centralized server may use the information to determine room dimension and layouts. The additional operations 1000 may include, at 1020, receiving an indication, from the server, to initiate the calculation subsequent to sending the indication. The additional operations 1000 may include, at 1030, synchronizing based on interactions with a server. The additional operations 1000 may include, at 1040, sending the at least one dimension to a server.

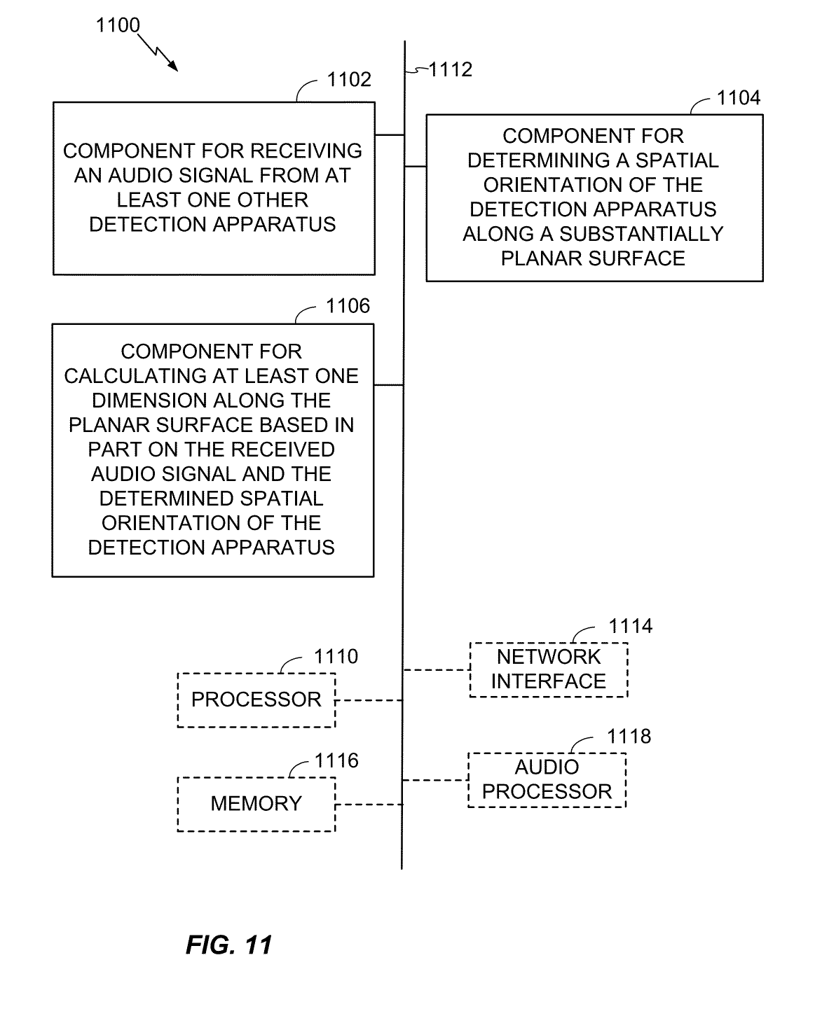

With reference to FIG. 11, there is provided an exemplary apparatus 1100 that may be configured as a sensor module or detection apparatus, or as a processor or similar device for use within the sensor module or detection apparatus, for determining room dimensions and layout. The apparatus 1100 may include functional blocks that can represent functions implemented by a processor, software, or combination thereof (e.g., firmware).

As illustrated, in one embodiment, the apparatus 1100 may include an electrical component or module 1102 for receiving an audio signal from at least one other detection apparatus. For example, the electrical component 1102 may include at least one control processor coupled to an audio processor or the like and to a memory with instructions for receiving an audio signal from at least one other detection apparatus. The electrical component 1102 may be, or may include, means for receiving an audio signal from at least one other detection apparatus. Said means may include an algorithm executed by one or more processors. The algorithm may include, for example, one of the algorithm 810 described above in connection with FIG. 8.

The apparatus 1100 may include an electrical component 1104 for determining a spatial orientation of the detection apparatus along a substantially planar surface. For example, the electrical component 1104 may include at least one control processor coupled to a memory holding instructions for determining a spatial orientation of the detection apparatus along the substantially planar surface. The electrical component 1104 may be, or may include, means for determining a spatial orientation of the detection apparatus along the substantially planar surface. Said means may include an algorithm executed by one or more processors. The algorithm may include, for example, one of the algorithm 820 described above in connection with FIG. 8.

The apparatus 1100 may include an electrical component 1106 for calculating at least one dimension along the planar surface based in part on the received audio signal and the determined spatial orientation of the detection apparatus. For example, the electrical component 1106 may include at least one control processor coupled to a memory holding instructions for calculating at least one dimension along the planar surface based in part on the received audio signal and the determined spatial orientation of the detection apparatus. The electrical component 1106 may be, or may include, means for calculating at least one dimension along the planar surface based in part on the received audio signal and the determined spatial orientation of the detection apparatus. Said means may include an algorithm executed by one or more processors. The algorithm may include, for example, one or more of the algorithms 810, 820, and 830 described above in connection with FIG. 8.

The apparatus 1100 may include similar electrical components for performing any or all of the additional operations 600, 700, or 800 described in connection with FIGS. 6-8, which for illustrative simplicity are not shown in FIG. 11.

In related aspects, the apparatus 1100 may optionally include a processor component 1110 having at least one processor, in the case of the apparatus 1100 configured as a system controller or computer server. The processor 1110, in such case, may be in operative communication with the components 1102-1106 or similar components via a bus 1112 or similar communication coupling. The processor 1110 may effect initiation and scheduling of the processes or functions performed by electrical components 1102-1106.

In further related aspects, the apparatus 1100 may include a network interface component 1114 for communicating with other network entities, for example, an Ethernet port or wireless interface. The apparatus 1100 may include an audio processor component 1118, for example a speech recognition module, for processing the audio signal to recognize user-specified control settings. The apparatus 1100 may optionally include a component for storing information, such as, for example, a memory device/component 1116. The computer readable medium or the memory component 1116 may be operatively coupled to the other components of the apparatus 1100 via the bus 1112 or the like. The memory component 1116 may be adapted to store computer readable instructions and data for performing the activity of the components 1102-1106, and subcomponents thereof, or the processor 1110, the additional operations 850 or 860, or the methods disclosed herein. The memory component 1116 may retain instructions for executing functions associated with the components 1102-1106. While shown as being external to the memory 1116, it is to be understood that the components 1102-1106 can exist within the memory 1116.

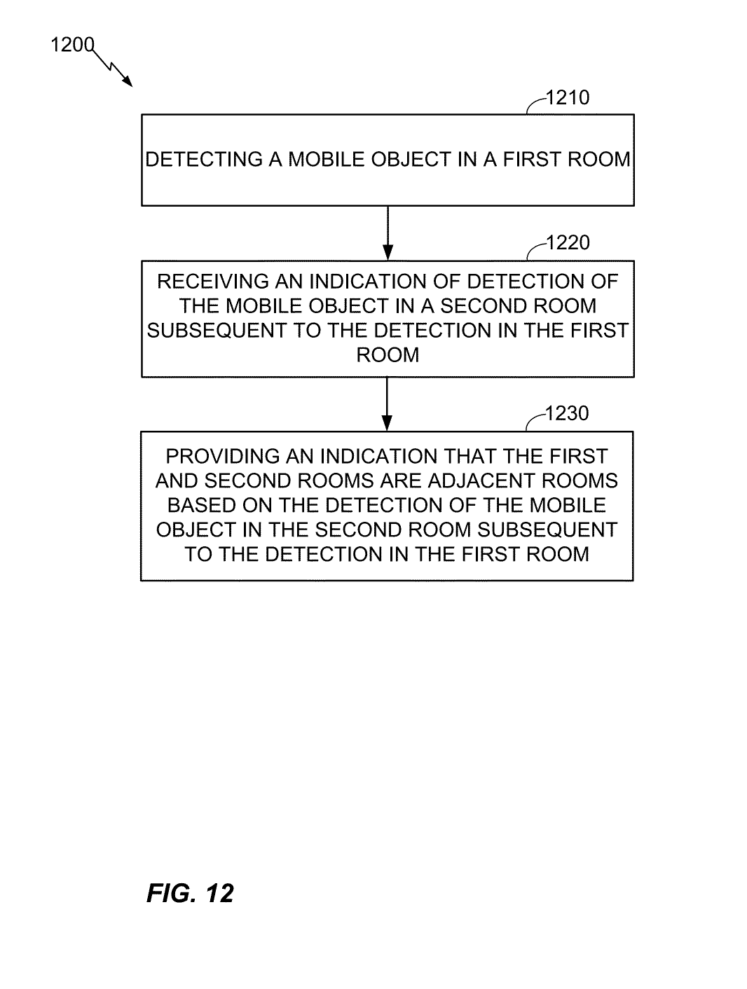

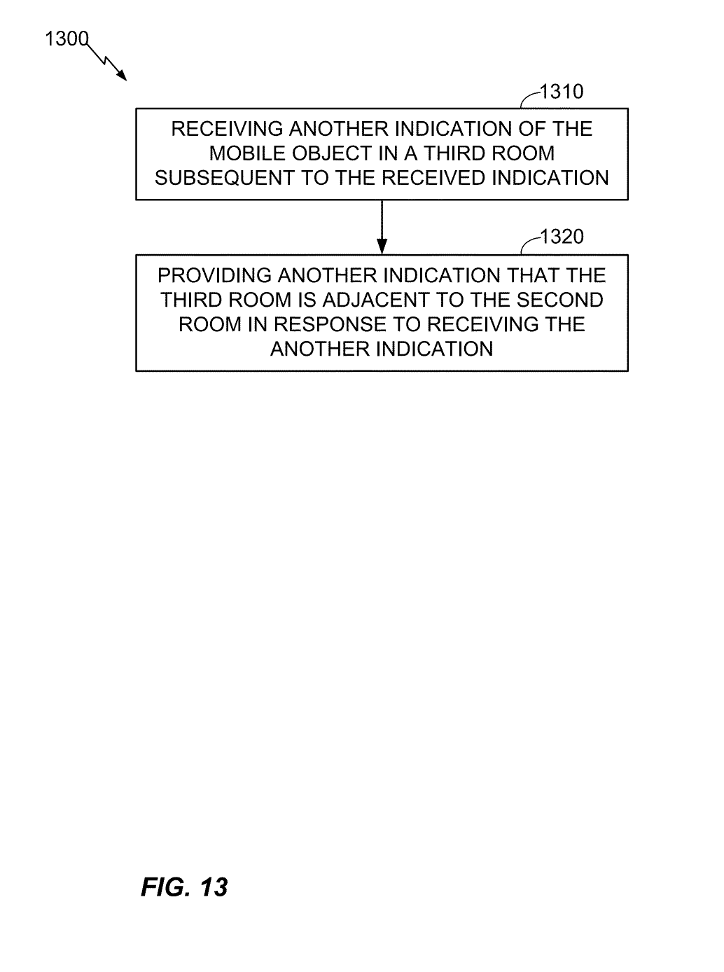

FIGS. 12-13 illustrate related methodologies for determining room layout by sensor modules.

The method 1200 may include, at 1210, detecting a mobile object in a first room. For example, the mobile object may be detected at a wireless radio of the sensor module or detection apparatus. For example, tomographic imaging through radio tomography may be used to detect the mobile object. The method may include, at 1220, receiving an indication of detection of the mobile object in a second room subsequent to the detection in the first room. For example, the indication of detection of the mobile object may be received at a receiver of the sensor module or detection apparatus. The method may include, at 1230, providing an indication that the first and second rooms are adjacent rooms based on the detection of the mobile object in the second room subsequent to the detection in the first room. For example, the indication that the first and second rooms are adjacent rooms may be stored to a memory of the sensor module or detection apparatus, transmitted via a transmitter to a server or to a wireless device.

Additional operations 1300 for determining room layout are illustrated in FIG. 13. One or more of operations 1300 may optionally be performed as part of method 1200. The operations 1300 may be performed in any operative order, or may be encompassed by a development algorithm without requiring a particular chronological order of performance. Operations may be independently performed and not mutually exclusive. Therefore any one of such operations may be performed regardless of whether another downstream or upstream operation is performed. For example, if the method 1200 includes at least one of the operations 1300 then the method 1200 may terminate after the at least one operation, without necessarily having to include any subsequent downstream operation(s) that may be illustrated.

Referring to FIG. 1300, the additional operations 1300 may include, at 1310, receiving another indication of the mobile object in a third room subsequent to the received indication. For example, the another indication of the mobile object may be received at the receiver of the sensor module or detection apparatus. The additional operations 1300 may include, at 1320, providing another indication that the third room is adjacent to the second room in response to receiving the another indication. For example, the indication that the second and third rooms are adjacent rooms may be stored to a memory of the sensor module or detection apparatus, transmitted via a transmitter to a server or to a wireless device.

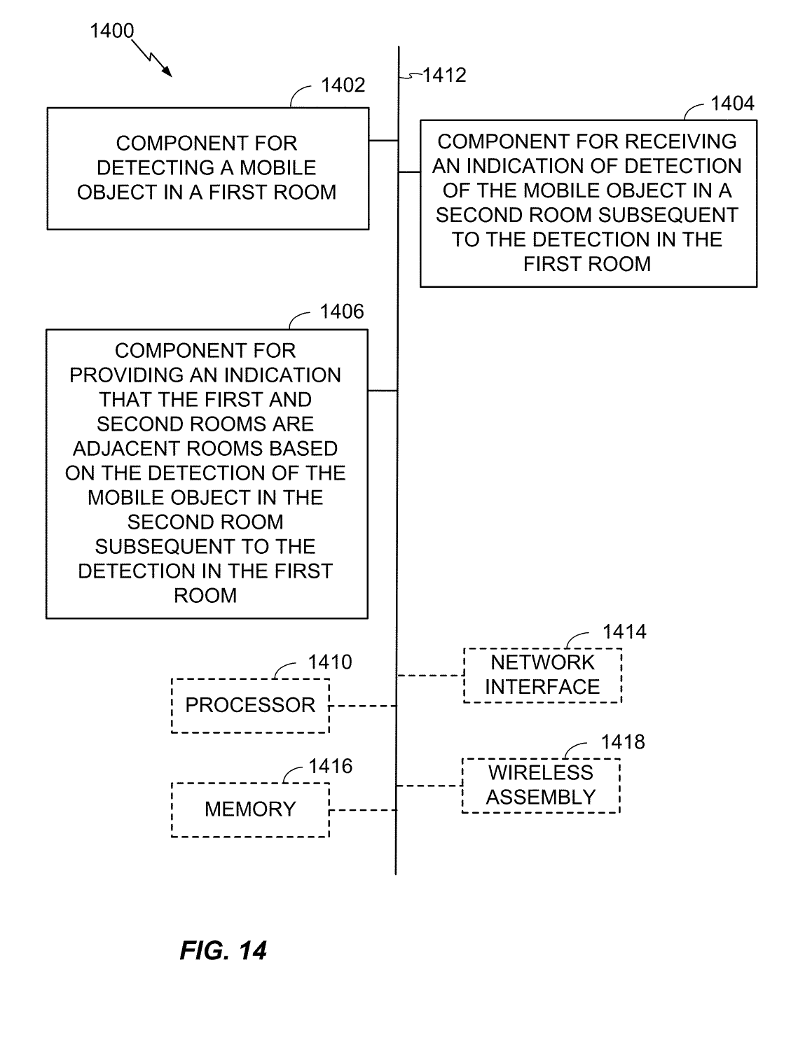

With reference to FIG. 14, there is provided an exemplary apparatus 1400 that may be configured as a sensor module or detection apparatus, or as a processor or similar device for use within the sensor module or detection apparatus, for determining room layout. The apparatus 1400 may include functional blocks that can represent functions implemented by a processor, software, or combination thereof (e.g., firmware).

As illustrated, in one embodiment, the apparatus 1400 may include an electrical component or module 1402 for detecting a mobile object in a first room. For example, the electrical component 1402 may include at least one control processor coupled to a wireless assembly or the like and to a memory with instructions for detecting the mobile object in the first room. The electrical component 1402 may be, or may include, means for detecting a mobile object in a first room. Said means may include an algorithm executed by one or more processors. The algorithm may include, for example, one of the algorithm 1210 described above in connection with FIG. 12.

The apparatus 1400 may include an electrical component 1404 for receiving an indication of detection of the mobile object in a second room subsequent to the detection in the first room. For example, the electrical component 1404 may include at least one control processor coupled to a receiver and to a memory holding instructions for receiving an indication of detection of the mobile object in a second room subsequent to the detection in the first room. The electrical component 1404 may be, or may include, means for receiving an indication of detection of the mobile object in a second room subsequent to the detection in the first room. Said means may include an algorithm executed by one or more processors. The algorithm may include, for example, one of the algorithm 1220 described above in connection with FIG. 12.

The apparatus 1400 may include an electrical component 1406 for providing an indication that the first and second rooms are adjacent rooms based on the detection of the mobile object in the second room subsequent to the detection in the first room. For example, the electrical component 1406 may include at least one control processor coupled to a memory, or at least one control processor coupled to a transmitter and to a memory holding instructions for providing an indication that the first and second rooms are adjacent rooms based on the detection of the mobile object in the second room subsequent to the detection in the first room. The electrical component 1406 may be, or may include, means for providing an indication that the first and second rooms are adjacent rooms based on the detection of the mobile object in the second room subsequent to the detection in the first room. Said means may include an algorithm executed by one or more processors. The algorithm may include, for example, one of the algorithm 1230 described above in connection with FIG. 12.

The apparatus 1400 may include similar electrical components for performing any or all of the additional operations 1300 described in connection with FIG. 13, which for illustrative simplicity are not shown in FIG. 14.

In related aspects, the apparatus 1400 may optionally include a processor component 1410 having at least one processor, in the case of the apparatus 1400 configured as a system controller or computer server. The processor 1410, in such case, may be in operative communication with the components 1402-1406 or similar components via a bus 1412 or similar communication coupling. The processor 1410 may effect initiation and scheduling of the processes or functions performed by electrical components 1402-1406.

In further related aspects, the apparatus 1400 may include a network interface component 1414 for communicating with other network entities, for example, an Ethernet port or wireless interface. The apparatus 1400 may include a wireless assembly component 1418, for example a transceiver module, for performing tomographic imaging. The apparatus 1400 may optionally include a component for storing information, such as, for example, a memory device/component 1416. The computer readable medium or the memory component 1416 may be operatively coupled to the other components of the apparatus 1400 via the bus 1412 or the like. The memory component 1416 may be adapted to store computer readable instructions and data for performing the activity of the components 1402-1406, and subcomponents thereof, or the processor 1410, the additional operations 850 or 860, or the methods disclosed herein. The memory component 1416 may retain instructions for executing functions associated with the components 1402-1406. While shown as being external to the memory 1416, it is to be understood that the components 1402-1406 can exist within the memory 1416.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and non-transitory communication media that facilitates transfer of a computer program from one place to another. A storage media may be any available media that can be accessed by a general purpose or special purpose computer. By way of example, and not limitation, such storage (non-transitory) computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection may be properly termed a computer-readable medium to the extent involving non-transitory storage of transmitted signals. Disk and disc, as used herein, includes compact disc (CD), laser disc, optical disc, digital versatile disc (DVD), floppy disk and Blu-ray disc where disks usually encode data magnetically, while discs hold data encoded optically. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for calculating dimensions of an enclosure comprising:
receiving, at a detection apparatus, an audio signal from at least one other detection apparatus;
determining a spatial orientation of the detection apparatus along a substantially planar surface of the enclosure; and
calculating at least one dimension along the planar surface based in part on the received audio signal and the determined spatial orientation of the detection apparatus.

2. The method of claim 1, wherein the receiving the audio signal comprises receiving the audio signal at a plurality of receivers spaced apart at a predetermined distance, wherein calculating at least one dimension is further based on a time difference in receiving the audio signal at the plurality of receivers.

3. The method of claim 1, wherein determining the spatial orientation comprises reading a compass or magnetometer.

4. The method of claim 1, further comprising receiving another spatial orientation of the at least one other detection apparatus, wherein calculating the at least one dimension is further based on the another spatial orientation of the at least one other detection apparatus.

5. The method of claim 1, further comprising detecting a proximate mobile object prior to receiving the audio signal.

6. The method of claim 5, further comprising sending an audio signal to the at least one other detection apparatus based on detecting the proximate mobile object.

7. The method of claim 1, wherein the least one dimension comprises at least three dimensions corresponding to at least three sides of the enclosure.

8. The method of claim 1, further comprising synchronizing a clock with the at least one other detection apparatus.

9. The method of claim 5, further comprising sending an indication of the detected proximate mobile object to a server.

10. The method of claim 9, further comprising receiving an indication, from the server, to initiate the calculation subsequent to sending the indication.

11. The method of claim 8, wherein synchronizing the clock comprises synchronizing based on interactions with a server.

12. The method of claim 1, further comprising sending the at least one dimension to a server.

13. An apparatus comprising:
means for receiving an audio signal from at least one other detection apparatus;
means for determining a spatial orientation of the apparatus along a substantially planar surface; and
means for calculating at least one dimension along the planar surface based in part on the received audio signal and the determined spatial orientation of the apparatus.

14. The apparatus of claim 13, wherein the receiving the audio signal comprises receiving the audio signal at a plurality of receivers spaced apart at a predetermined distance, wherein calculating at least one dimension is further based on a time difference in receiving the audio signal at the plurality of receivers.

15. The apparatus of claim 13, wherein determining the spatial orientation comprises reading a compass or magnetometer.

16. The apparatus of claim 13, further comprising receiving another spatial orientation of the at least one other detection apparatus, wherein calculating the at least one dimension is further based on the another spatial orientation of the at least one other detection apparatus.

17. The apparatus of claim 13, further comprising detecting a proximate mobile object prior to receiving the audio signal.

18. The apparatus of claim 17, further comprising sending an audio signal to the at least one other detection apparatus based on detecting the proximate mobile object.

19. An apparatus comprising:
at least one processor configured for receiving an audio signal from at least one other detection apparatus, determining a spatial orientation of the apparatus along a substantially planar surface, and calculating at least one dimension along the planar surface based in part on the received audio signal and the determined spatial orientation of the apparatus; and
a memory component, in operative communication with the at least one processor, for storing data.

20. The apparatus of claim 19, wherein the receiving the audio signal comprises receiving the audio signal at a plurality of receivers spaced apart at a predetermined distance, wherein calculating the at least one dimension is further based on a time difference in receiving the audio signal at the plurality of receivers.

21. The apparatus of claim 19, wherein determining the spatial orientation comprises reading a compass or magnetometer.

22. The apparatus of claim 19, further comprising receiving another spatial orientation of the at least one other detection apparatus, wherein calculating the at least one dimension is further based on the another spatial orientation of at least one other detection apparatus.

23. The apparatus of claim 19, further comprising detecting a proximate mobile object prior to receiving the audio signal.

24. The apparatus of claim 23, further comprising sending an audio signal to the at least one other detection apparatus based on detecting the proximate mobile object.

25. A computer program product comprising:
a computer-readable medium comprising code for causing a computer to:
receive an audio signal from at least one other detection apparatus;
determine a spatial orientation of the a detection apparatus along a substantially planar surface; and
calculating at least one dimension along the planar surface based in part on the received audio signal and the determined spatial orientation of the detection apparatus.

26. The computer program product of claim 25, wherein the receiving the audio signal comprises receiving the audio signal at a plurality of receivers spaced apart at a predetermined distance, wherein calculating the at least one dimension is further based on a time difference in receiving the audio signal at the plurality of receivers.

27. The computer program product of claim 25, wherein determining the spatial orientation comprises reading a compass or magnetometer.

28. The computer program product of claim 25, further comprising receiving another spatial orientation of the at least one other detection apparatus, wherein calculating the at least one dimension is further based on the another spatial orientation of the at least one other detection apparatus.

29. The computer program product of claim 25, further comprising detecting a proximate mobile object prior to receiving the audio signal.

30. The computer program product of claim 29, further comprising sending an audio signal to the at least one other detection apparatus based on detecting the proximate mobile object.

31. A method for determining room layout, the method comprising:
detecting a mobile object in a first room;
receiving an indication of detection of the mobile object in a second room subsequent to the detection in the first room; and
providing an indication that the first and second rooms are adjacent rooms based on the detection of the mobile object in the second room subsequent to the detection in the first room.

32. The method of claim 31, wherein the detecting the mobile object in the first room comprises motion detection of the mobile object.

33. The method of claim 32, wherein the motion detection comprises detection by radio tomography.

34. The method of claim 31, further comprising receiving another indication of the mobile object in a third room subsequent to the received indication; and
providing another indication that the third room is adjacent to the second room in response to receiving the another indication.

35. The method of claim 31, wherein providing the indication comprises at least one of storing, transmitting to a server, or transmitting to a wireless device the indication that the first and second rooms are adjacent rooms.

36. An apparatus comprising:
means for detecting a mobile object in a first room;
means for receiving an indication of detection of the mobile object in a second room subsequent to the detection in the first room; and
means for providing an indication that the first and second rooms are adjacent rooms based on the detection of the mobile object in the second room subsequent to the detection in the first room.

37. The apparatus of claim 36, further comprising means for receiving another indication of the mobile object in a third room subsequent to the received indication; and
wherein the means for providing the indication is further configured for providing another indication that the third room is adjacent to the second room in response to receiving the another indication.

38. An apparatus comprising:
at least one processor configured for detecting a mobile object in a first room, receiving an indication of detection of the mobile object in a second room subsequent to the detection in the first room, and providing an indication that the first and second rooms are adjacent rooms based on the detection of the mobile object in the second room subsequent to the detection in the first room; and
a memory component, in operative communication with the at least one processor, for storing data.

39. The apparatus of claim 38, wherein the at least one processor is further configured for receiving another indication of the mobile object in a third room subsequent to the received indication, and providing another indication that the third room is adjacent to the second room in response to receiving the another indication.

40. A computer program product comprising:
a computer-readable medium comprising code for causing a computer to:
detect a mobile object in a first room;
receive an indication of detection of the mobile object in a second room subsequent to the detection in the first room; and
provide an indication that the first and second rooms are adjacent rooms based on the detection of the mobile object in the second room subsequent to the detection in the first room.

41. The computer program product of claim 40, wherein the computer-readable medium further comprises code for causing the computer to:
receive another indication of the mobile object in a third room subsequent to the received indication; and
provide another indication that the third room is adjacent to the second room in response to receiving the another indication.
